(19) United States
(12) Patent Application Publication
(10) Pub. No.: US 2008/0258119 A1
(43) Pub. Date: Oct. 23, 2008

(54) Squeezable, Cross-Linked, Grease-Like Electromagnetic Wave Absorber

(75) Inventors: Tatsuya Kobayashi, Shizuoka-shi (JP); Orle Furutani, Shizuoka-shi (JP)

Correspondence Address: EDWARDS ANGELL PALMER & DODGE LLP, P.O. BOX 55874, BOSTON, MA, 02205, US

(73) Assignee: Geltec Co., Ltd., Tokyo (JP)

(21) Appl. No.: 10/590,853

(22) PCT Filed: Oct. 20, 2004
(86) PCT No.: PCT/JP04/15489

§ 371 Date: Jul. 25, 2007

(30) Foreign Application Priority Data
Mar. 30, 2004 (JP) 2004-099880

(51) Int. Cl. G03C 1/00

(52) U.S. Cl. 252/600

(57) ABSTRACT

The present invention provides a squeezable, cross-linked, grease-like electromagnetic wave absorber which comprises a cross-linked silicone gel preferably having a consistency of 50 to 200 (determined in accordance with JIS K 2220 with a ¼ cone), dispersed with an electromagnetic wave absorbing filler preferably comprising an electromagnetic wave absorbing agent and flame retardant; shows self-shape-retaining nature in spite of its fluidity; contains the filler at 200 to 800 parts by mass per 100 parts by mass of the cross-linked silicone gel; is excellent in electromagnetic wave absorbing capability, thermal conductivity and flame retardancy; has limited temperature dependency; is squeezable; and is applicable to a gap and site to be formed into a thin film thereon, to which a sheet product is essentially inapplicable.

### BACKGROUND OF THE INVENTION

1. Field of the Invention

The present invention relates to a squeezable, cross-linked, grease-like electromagnetic wave absorber, container which contains the absorber, method for producing the container and method for using the absorber and container for absorbing electromagnetic waves; in particular to a squeezable, cross-linked, grease-like electromagnetic wave absorber excellent in electromagnetic wave absorbing, capability, thermal conductivity and flame retardancy, having limited temperature dependency, and applicable to a gap and site to be formed into a thin film thereon, to which a sheet product is essentially inapplicable, container which contains the absorber, method for producing the container and method for using the absorber and container for absorbing electromagnetic waves.

2. Description of the Prior Art

Recently, troubles caused by electromagnetic waves, e.g., radio interferences and electronic device errors, have been frequently occurring, because of expanded utilization of electromagnetic waves by broadcasting, communication by moving devices, radars, cellular phones, wireless LANs and so forth, which massively scatter electromagnetic waves in living spaces. In particular, unnecessary electromagnetic waves (noises) radiated from elements in devices which generate electromagnetic waves and patterns on printed boards cause interference and resonance phenomena. These problems have called for urgent measures against electromagnetic waves in neighborhood electromagnetic fields, which induce deteriorated device functions and reliability, and increased heat emitted from arithmetic elements which are speeding up increasingly.

Some of the major measures against these problems taken so far include reflection for returning noises back to the source, by-passing for directing noises to a stable potential surface (e.g., by grounding) and shielding.

None of these methods, however, has sufficiently achieved measures against electromagnetic waves in neighborhood electromagnetic fields and increased heat radiation simultaneously for various reasons. Elements are mounted at a higher density to satisfy requirements for compacter and lighter assemblies, which tends to cut spaces for devices for controlling noises. Elements are driven at a lower voltage to satisfy requirements for energy-saving, with the result that their power sources tend to be interfered with high-frequency waves radiated from another medium. Arithmetic elements have narrowed clock signals to satisfy requirements for higher processing speed, with the result that they are more sensitive to high-frequency waves. Resin boxes tend to have structures which allow electromagnetic waves to leak out more easily as they are rapidly spreading, with the result that they are interfered with each other as available frequency bands rapidly expand.

Electromagnetic wave absorbers are now spreading to convert noises, emitted from elements and patterns on printed boards contained in boxes, into heat energy to solve these problems. The absorbers are required to have functions of absorbing electromagnetic energy of noises by utilizing magnetism loss characteristics and converting it into heat energy to control noise reflection and transmission in boxes, and functions of adding an impedance to the electromagnetic energy emitted from board patterns and element terminals working as antennas to deteriorate the antenna effects and thereby to reduce the electromagnetic energy level. There are demands for the absorbers which fully exhibit these functions.

One of the absorbers proposed to solve these problems is a flexible, thin laminate of a flexible, sheet-shape wave absorption layer and wave reflection layer, the former being of a mixture of materials, one for dissipating and the other for retaining electromagnetic energy, and the latter of an organic fiber fabric electrolessly plated with a highly electroconductive metal (JP-B-3097343).

Various measures for shielding electromagnetic waves have been adopted. For examples, some devices are provided with a metallic shielding plate to prevent leakage of electromagnetic waves outwards. Some devices are contained in boxes treated to have electroconductivity and hence electromagnetic wave shielding capability. These shielding materials involve problems, e.g., electromagnetic waves reflected and scattered by them fill device insides to complicate electromagnetic interferences, or cause interferences between boards in a device. One of the proposals to solve these problems is controlling electromagnetic interferences by a laminate of electroconductive supporter coated with an electrically insulating, soft magnetic layer of soft magnetic powder and an organic binder (JP-A-7-212079).

JP-A-2002-329995 discloses a laminated electromagnetic wave absorber composed of an electromagnetic wave reflection layer coated, at least on one side, with an electromagnetic wave absorption layer, where the reflection layer comprises an electroconductive filler dispersed in a silicone resin and the absorption layer comprises an electromagnetic wave absorbing filler dispersed in a silicone resin. It is claimed to have high electromagnetic wave absorbing and shielding capabilities, and, at the same time, high moldability, flexibility, weather resistance and heat resistance coming from the silicone resin itself JP-A-11-335472 discloses a sheet of electromagnetic wave absorbing, thermoconductive silicone gel composition containing magnetic particles of metal oxide (e.g., ferrite) and thermoconductive filler of metal oxide or the like.

Each of the above techniques, however, provides an electromagnetic wave absorber structure in the form of sheet or the like. The sheet-shape absorber cannot be sufficiently applicable to some boxes which have complicated surfaces, e.g., those with openings (slits or the like) for improved heat radiation effect, because it needs special treatment, e.g., cutting in a complex manner. Several materials have been proposed to be applied to such surfaces, e.g., electrically insulating paste of high permeability for electromagnetic wave shielding, which contains 200 to 900 parts by mass of soft magnetic powder per 100 parts by mass of electrically insulating resin (JP-A-4-352498); electromagnetic wave absorbing adhesive agent of viscous mixture comprising sendust soft magnetic powder containing an organic binder and coupling agent (JP-A-11-50029); composite magnetic paste of putty composition containing flat, Fe—Al—Si alloy powder and an organic binder (JP-A-11-54985); liquid composition for preventing wave interferences, comprising silicone resin or the like incorporated with carbon fibers, magnetic particles and graphitized carbon (JP-A-2000-244173); electromagnetic wave shielding material comprising a thermosetting resin or the like, which remains liquid when applied, incorporated with magnetic particles (JP-A-2001-284877); and electromagnetic wave absorbing paste prepared by kneading an electromagnetic wave absorbing material of magnetic particles and an organic binder (JP-A-2001-77585). However, each material tends to trickle down, bleed to the surrounding area and separate from a magnetic powder, and hence is difficult to apply to an aimed site sufficiently thinly. Moreover, it is difficult to handle, because it cannot be easily contained in a container, e.g., tube or syringe.

### SUMMARY OF THE INVENTION

The present invention has been developed to solve the problems described above. It is an object of the present invention to provide a squeezable, cross-linked, grease-like electromagnetic wave absorber which has improved characteristics to prevent undesirable phenomena (trickling down, bleeding to the surrounding area and separation from a filler with which it is used); can be contained in a container (e.g., tube or syringe) like grease, paste, clay or the like; is squeezable from a container by a weak force (e.g., by hand from a tube or by air which presses a syringe piston); can be formed into any shape by a force after being squeezed out from the container; shows no diffusion phenomenon (bleeding phenomenon) in a device in which it is used; can retain its shape intact so long as it is allowed to remain as it is in the ordinary course of events even when exposed to a light load (e.g., that occurring when it is placed on a slanted object), i.e., showing self-shape-retaining nature; shows limited temporal aging; is excellent in electromagnetic wave absorbing capability, thermal conductivity and flame retardancy; has limited temperature dependency; and is applicable to a gap and site to be formed into a thin film thereon, to which a sheet product is essentially inapplicable. The other objects of the present invention are to provide a container which contains the absorber, a method for producing the container, and a method for using the absorber and container for absorbing electromagnetic waves.

The inventors of the present invention have found, after having extensively studied to solve the above problems, that a squeezable, cross-linked, grease-like electromagnetic wave absorber produced by heating a starting material for silicone gel after it is dispersed with a filler for absorbing electromagnetic waves is unexpectedly movable by a weak force, e.g., that produced by a syringe piston, although it was at first considered to be unmovable because it is a cross-linked product; can be formed into a specific shape; shows self-shape-retaining nature by which it can retain its shape intact so long as it is allowed to remain as it is in the ordinary course of events even when exposed to a light load (e.g., that occurring when it is placed on a slanted object); shows excellent electromagnetic wave absorption capability, thermal conductivity and flame retardancy, when incorporated preferably with soft ferrite and/or flat, soft magnetic metal powder each working as an electromagnetic wave absorbing agent, and further preferably with a composite filler containing magnetite as a flame retardant at a specific content; has limited temperature dependency; and is applicable to a gap and site to be formed into a thin film thereon, to which a sheet product is essentially inapplicable, achieving the present invention.

The first aspect of the present invention is a squeezable, cross-linked, grease-like electromagnetic wave absorber comprising a cross-linked silicone gel dispersed with an electromagnetic wave absorbing filler, which shows self-shape-retaining nature in spite of its fluidity and contains the filler at 200 to 800 parts by mass per 100 parts by mass of the cross-linked silicone gel.

The second aspect of the present invention is the squeezable, cross-linked, grease-like electromagnetic wave absorber of the first aspect, wherein the cross-linked silicone gel has a consistency of 50 to 200, determined in accordance with JIS K 2220 with a ¼ cone.

The third aspect of the present invention is the squeezable, cross-linked, grease-like electromagnetic wave absorber of the first or second aspect, wherein the electromagnetic wave absorbing filler is a mixture of electromagnetic wave absorbing agent and flame retardant.

The fourth aspect of the present invention is the squeezable, cross-linked, grease-like electromagnetic wave absorber of the third aspect, wherein the electromagnetic wave absorbing agent is of a soft ferrite surface-treated with a silane compound having a non-functional group and/or flat, soft magnetic metal powder.

The fifth aspect of the present invention is the squeezable, cross-linked, grease-like electromagnetic wave absorber of the fourth aspect, wherein the soft ferrite surface-treated with a silane compound having a non-functional group is surface treated with dimethyldimethoxy silane or methyltrimethoxy silane.

The sixth aspect of the present invention is the squeezable, cross-linked, grease-like electromagnetic wave absorber of the fourth or fifth aspect, wherein the soft ferrite surface-treated with a silane compound having a non-functional group is kept at a pH of 8.5 or less.

The seventh aspect of the present invention is the squeezable, cross-linked, grease-like electromagnetic wave absorber of one of the third to sixth aspects, wherein the flame retardant is of magnetite.

The eighth aspect of the present invention is a container which contains the squeezable, cross-linked, grease-like electromagnetic wave absorber of one of the first to seventh aspects.

The ninth aspect of the present invention is the container of the eighth aspect which takes a form of syringe or tube.

The tenth aspect of the present invention is a method for producing the container of the eighth or ninth aspect, wherein a squeezable, cross-linked, grease-like electromagnetic wave absorber, produced by heating a mixture of starting material for a cross-linked silicone gel and electromagnetic wave absorbing filler while or after they are mixed to disperse the filler in the absorber, is contained therein.

The 11^{th} aspect of the present invention is a method for producing the container of the eighth or ninth aspect, wherein a squeezable, cross-linked, grease-like electromagnetic wave absorber is produced by heating the container which has already contained a mixed solution of starting material for a cross-linked silicone gel and electromagnetic wave absorbing filler to disperse the filler in the absorber.

The 12^{th} aspect of the present invention is a method for absorbing unnecessary electromagnetic waves, wherein the squeezable, cross-linked, grease-like electromagnetic wave absorber contained in the container of the eighth or ninth aspect is applied to an area around an opening for heat radiation on a box to be formed into a thin film thereon to control radiation of unnecessary electromagnetic waves from the opening.

The squeezable, cross-linked, grease-like electromagnetic wave absorber of the present invention is excellent in electromagnetic wave absorbing capability, thermal conductivity and flame retardancy; has limited temperature dependency; and is applicable to a gap and site to be formed into a thin film thereon, to which a sheet product is essentially inapplicable.

Moreover, the squeezable, cross-linked, grease-like heat-radiating material of the present invention can be contained in a container (e.g., tube or syringe) like grease, paste, clay or the like, and hence is squeezable from the container by a weak force (e.g., by hand from a tube or by air which presses a syringe piston); can be formed into any shape by a force after being squeezed out from a container, the formed shape showing self-shape-retaining nature by which it retains its shape intact so long as it is allowed to remain as it is in the ordinary course of events even when exposed to a light load (e.g., that occurring when it is placed on a slanted object) and also showing limited temporal aging because it is already cross-linked. As such, the present invention provides a novel electromagnetic wave absorber different from the conventional ones.

### BRIEF DESCRIPTION OF THE DRAWINGS

FIG. 1 present measured magnetism loss results of the electromagnetic wave absorber prepared in EXAMPLE.

### DETAILED DESCRIPTION OF THE INVENTION

The squeezable, cross-linked, grease-like electromagnetic wave absorber of the present invention comprises a cross-linked silicone gel dispersed with an electromagnetic wave absorbing filler. The container of the present invention contains the squeezable, cross-linked, grease-like electromagnetic wave absorber. The method of the present invention for producing the container provides a method by which the squeezable, cross-linked, grease-like electromagnetic wave absorber is contained. The constituent components of the absorber, container and method for producing the absorber and container are described below.

### 1. Cross-Linked Silicone Gel

The squeezable, cross-linked, grease-like electromagnetic wave absorber of the present invention comprises a cross-linked silicone gel as a matrix material. Cross-linked silicone gel itself is a known substance. However, it should satisfy various conditions for the squeezable, cross-linked, grease-like electromagnetic wave absorber of the present invention. More specifically, it is particularly preferable that it is fluid as to be squeezable from a syringe or tube, shows plasticity and self-shape-retaining nature even when massively incorporated with an electromagnetic wave absorbing filler, is free of a low-molecular-weight silicone compound, and contains alkenyl group to a limited extent and residual hydrogen group directly bound to the silicone atom.

The cross-linked silicone gel has a consistency of 50 to 200, determined in accordance with JIS K 2220 with a ¼ cone. Consistency beyond the above range is not desirable. A silicone gel having a consistency of above 200 may lose self-shape-retaining nature to bleed or diffuse into the surrounding area when it is applied. On the other hand, a silicone gel having a consistency of below 50 may lose fluidity.

The method for producing the cross-linked silicone gel for the present invention is not limited. However, it is normally produced from organohydrogen polysiloxane and alkenylpolysiloxane, described later, as starting materials by hydrosilylation (addition reaction) in the presence of a catalyst. In other words, starting materials for the silicone gel for the present invention are organohydrogen polysiloxane and alkenylpolysiloxane in many cases. An organohydrogen polysiloxane as one of the starting materials for the present invention is preferably the one represented by the general formula (1):

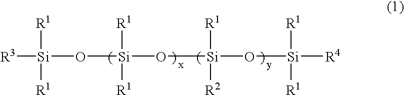

In the formula (1), R¹ is a substituted or unsubstituted monovalent hydrocarbon group, where R's may be the same or different; R², R³ and R⁴ are each R¹ or —H, at least 2 of R², R³ and R⁴ being —H; “x” and “y” are each an integer representing number of each unit, each unit being configured in a block or preferably random manner, where “x” is an integer of 0 or more but preferably 10 to 30, “y” is an integer of 0 or more but preferably 1 to 10, “x+y” is an integer of 5 to 300, but preferably 30 to 200, and “y/(x+y)” is preferably 0.1 or less, because the cross-linked grease-like material may no longer obtained for the present invention due to the presence of an excessive number of cross-linking points when the ratio exceeds 0.1. Examples of the hydrocarbon group R¹ include alkyl groups, e.g., methyl, ethyl, propyl and butyl; cycloalkyl groups, e.g., cyclopentyl and cyclohexyl; aryl groups, e.g., phenyl and tolyl; and aralkyl groups, e.g., benzyl and phenylethyl, where hydrogen atoms of these groups may be partly substituted with a halogen atom, e.g., chlorine or fluorine, to form a halogenated hydrocarbon.

The hydrogen atom directly bound to the silicon atom (Si—H) is necessary to activate the addition reaction (hydrosilylation) with the alkenyl group directly or indirectly bound to the silicon atom. At least the two hydrogen atoms are required in the organohydrogen polysiloxane molecule. In the presence of an insufficient number of the hydrogen atoms directly bound to the silicon atom, the silicone gel may not be formed due to an insufficient number of the cross-linking points, with the result that the product will have properties not much different from those of silicone oil. In the presence of an excessive number of the hydrogen atoms directly bound to the silicon atom, on the other hand, the product will have properties not much different from those of silicone rubber due to an excessive number of the cross-linking points. It is needless to say that there is an optimum ratio of number of the Si—H group in the organohydrogen polysiloxane to that of the alkenyl group in the alkenylpolysiloxane. The ratio S—H group/alkenyl group is preferably in a range of from 0.85 to 1.25, particularly preferably from 0.9 to 1.1. When the ratio is within the above range, number of the residual alkenyl group is limited to prevent oxidation-caused deterioration of the silicone gel in an electronic device, in which it is exposed to high temperature, and, at the same time, number of the residual Si—H group is limited to prevent deterioration of gel thermal conductivity resulting from evolution of hydrogen.

An alkenylpolysiloxane as the other starting material for the present invention is preferably the one represented by the general formula (2):

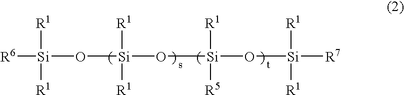

In the formula (2), R¹ is a substituted or unsubstituted monovalent hydrocarbon group, where R¹s may be the same or different; R⁵, R⁶ and R⁷ are each R¹ or an alkenyl group, at least 2 of R⁵, R⁶ and R⁷ being an alkenyl group; “s” and “t” are each an integer representing number of each unit, each unit being configured in a block or preferably random manner, where “s” is an integer of 0 or more, “t” is an integer of 0 or more, “s+t” is an integer of 10 to 600, and “t/(s+t)” is preferably 0.1 or less, because the cross-linked grease-like material may no longer obtained for the present invention due to the presence of an excessive number of cross-linking points when the ratio exceeds 0.1. Examples of the hydrocarbon group R¹ include alkyl groups, e.g., methyl, ethyl, propyl and butyl; cycloalkyl groups, e.g., cyclopentyl and cyclohexyl; aryl groups, e.g., phenyl and tolyl; and aralkyl groups, e.g., benzyl and phenylethyl, where hydrogen atoms of these groups may be partly substituted with a halogen atom, e.g., chlorine or fluorine, to form a halogenated hydrocarbon.

The alkenyl group (e.g., vinyl or allyl group) directly or indirectly bound to the silicon atom is necessary to activate the addition reaction (hydrosilylation) with the hydrogen atom directly bound to the silicon atom (Si—H). At least the two alkenyl groups are required in the alkenylpolysiloxane molecule. In the presence of an insufficient number of the alkenyl group, the silicone gel may not be formed due to an insufficient number of the cross-linking points, with the result that the product will have properties not much different from those of silicone oil. In the presence of an excessive number of the alkenyl group, on the other hand, the product will have properties not much different from those of silicone rubber due to an excessive number of the cross-linking points. It is needless to say that there is an optimum ratio of number of the alkenyl group in the alkenylpolysiloxane to that of the Si—H group in the organohydrogen polysiloxane. The ratio S—H group/alkenyl group is preferably in a range of from 0.85 to 1.25, particularly preferably from 0.9 to 1.1, for the reasons described above. The number “s+t” determines distance between the cross-linking points. When it is excessively small, number of the cross-linking points is excessively large. When it is excessively large, on the other hand, number of the cross-linking points is insufficient, with the result that the product will have an excessively high molecular weight to be smoothly discharged from a syringe.

The hydrogen polysiloxane for the present invention, represented by the general formula (1), has the hydrogen group (—H) directly bound to the silicon atom, and the alkenylpolysiloxane represented by the general formula (2) has the carbon-carbon double bond. The double bond and hydrogen group cause an addition reaction, referred to as hydrosilylation.

The hydrosilylation reaction may be carried out by a known technique, in the presence or absence of an organic solvent. The organic solvents useful for the reaction include alcohols, e.g., ethanol and isopropyl alcohol; aromatic hydrocarbons, e.g., toluene and xylene; ethers, e.g., dioxane and THF; aliphatic hydrocarbons; and chlorinated hydrocarbons. It is carried out normally at 50 to 150° C. in the presence of a catalyst, e.g., chloroplatinic acid, chloroplatinic acid/alcohol complex, platinum/olefin complex, platinum/vinyl siloxane complex or platinum/phosphorus complex. The catalyst is incorporated in the reaction system normally at 1 to 500 ppm by mass as platinum on the alkenylpolysiloxane, preferably 3 to 250 ppm by mass in consideration of product curability and physical properties of the cured product.

### 2. Electromagnetic Wave Absorbing Filler

The electromagnetic wave absorbing filler which can be incorporated in the cross-linked silicone gel for the present invention is not limited, so long as it has a function of absorbing electromagnetic waves. Examples of the filler useful for the present invention include soft ferrite and flat, soft magnetic metal powder. These may be used either individually or in combination. Moreover, the filler is preferably incorporated with a flame retardant to form a composite filler.

The soft ferrite useful as an electromagnetic wave absorber which can be incorporated in the cross-linked silicone gel for the present invention is selected from the ones which can exhibit a magnetic function even at a very low excitation current. The soft ferrite is not limited for the present invention. Examples of the soft ferrite useful for the present invention include Ni—Zn, Mn—Zn, Mn—Mg, Cu—Zn, Ni—Zn—Cu, Fe—Ni—Zn—Cu, Fe—Mg—Zn—Cu and Fe—Mn—Zn ferrites, of which Ni—Zn ferrite is more preferable in consideration of a balance among electromagnetic wave absorption characteristics, thermal conductivity, cost and so forth.

The soft ferrite particle is not limited in shape. It may take any desired shape, e.g., spherical, fibrous or indefinite. It is preferably spherical for the present invention, because the soft ferrite can be densely packed to give a higher thermal conductivity. The spherical soft ferrite powder has a particle size at which it is densely packed and, at the same time, prevented from agglomerating with each other to facilitate the mixing work.

The spherical Ni—Zn ferrite particles are well dispersible in silicone gel, described above, without inhibiting cure of the gel, while exhibiting a thermal conductivity to some extent.

The soft ferrite has a particle size distribution D₅₀ of 1 to 30 μm, preferably 1 to 10 μm. The distribution D₅₀ beyond the above range is not desirable. When it is below 1 μm, the absorber may have a deteriorated electromagnetic wave absorption capability at a low frequency band of 500 MHz or less. When it is above 30 μm, on the other hand, the absorber may have deteriorated flatness/smoothness.

The particle size distribution D₅₀ represents a size range around the midpoint in a cumulative distribution in which sizes determined by a particle size distribution meter are arranged in an ascending order.

It is necessary to treat the soft ferrite for the present invention with a silane compound having a non-functional group, in order to control effects of the alkali ion remaining on the surface. The soft ferrite is incorporated in silicone described above, and the alkali ion remaining on the surface may inhibit cure of the silicone effected by a condensation or addition mechanism. When cure of the silicone is inhibited, the soft ferrite may be insufficiently packed and dispersed.

The soft ferrite surface-treated with a silane compound having a non-functional group has a pH of 8.5 or less, preferably 8.2 or less, more preferably 7.8 to 8.2. Keeping the soft ferrite at a pH of 8.5 or less controls the inhibition effect on cure of the silicone and makes it applicable to any type of silicone. Moreover, it improves compatibility of the soft ferrite with the silicone, allowing it to be incorporated in the silicone at a higher content and increasing its compatibility with a thermoconductive filler to make the formed article more uniform.

The silane compounds having a non-functional group useful for the present invention for surface treatment of the soft ferrite include methyltrimethoxy silane, phenyltrimethoxy silane, diphenyldimethoxy silane, methyltriethoxy silane, dimethyldimethoxy silane, phenyltriethoxy silane, diphenyldiethoxy silane, isobutyltrimethoxy silane and decyltrimethoxy silane, of which dimethyldimethoxy silane and methyltrimethoxy silane are more preferable. They may be used either individually or in combination.

A common silane coupling agent having a functional group, e.g., epoxy- or vinyl-based one, which is used for surface treatment of filler or the like, is not desirable for surface treatment of the soft ferrite for the present invention, because it may cause hardness change of increased hardness in an environment test carried out under heating. The increased hardness, when occurs, may lead to cracking or the like caused by thermal decomposition and damages of external appearance.

The method for surface treatment of the soft ferrite with the silane compound having a non-functional group is not limited, and a common method with an inorganic compound, e.g., silane compound, may be adopted. For example, the soft ferrite is immersed in a methyl alcohol solution containing dimethyldimethoxy silane at around 5% by mass to be mixed with the silane compound, to which water is added for hydrolysis, and the product is then milled and mixed by a Henschel mixer and the like. The silane compound having a non-functional group is preferably incorporated at around 0.2 to 10% by mass on the soft ferrite.

The flat, soft magnetic metal powder which can be incorporated in the cross-linked silicone gel for the present invention is a material which has an effect of securing a stable energy conversion efficiency in a broad frequency band of MHz to 10 GHz.

The flat, soft magnetic metal powder is not limited, so long as it exhibits soft magnetism and can be mechanically flattened. It preferably has a high permeability, low self-oxidation rate and shape of high aspect ratio (average particle size divided by average thickness). More specifically, the metals useful for the present invention include soft magnetic ones, e.g., Fe—Ni, Fe—Ni—Mo, Fe—Ni—Si—B, Fe—Si, Fe—Si—Al, Fe—Si—B, Fe—Cr, Fe—Cr—Si, Co—Fe—Si—B, Al—Ni—Cr—Fe and Si—Ni—Cr—Fe alloys, of which Al-based and Si—Ni—Cr—Fe alloys are more preferable particularly viewed from their low self-oxidation rate. They may be used either individually or in combination.

Degree of self-oxidation can be measured by mass change of a sample, determined by an atmospheric exposure test under heating. It is preferable that the degree is 0.3% by mass or less when a sample is kept at 200° C. in air for 300 hours. Flat, soft magnetic metal powder of low self-oxidation rate has an advantage of being resistant to temporal aging in magnetic characteristics resulting from changed ambient conditions, e.g., humidity, even when it is incorporated with a highly moisture-permeable silicone gel or the like as a binder resin.

Powder of low self-oxidation rate has another advantage that it can be massively stored and handled easily to improve productivity, because it involves no risk of dust explosion and considered to be non-hazardous.

The flat, soft magnetic metal powder preferably have an average thickness of 0.01 to 1 μm. The particles having an average thickness of below 0.01 μm may have deteriorated dispersibility in a resin, and may not be sufficiently oriented unidirectionally when orientation-treated in an external magnetic field. At the same time, they may have deteriorated magnetic properties (e.g., permeability) and magnetism shielding characteristics, even when they are of the same composition. On the other hand, those having an average thickness of above 1 μm may not be packed at a sufficient density. They are more sensitive to a diamagnetic field, because of decreased aspect ratio, which leads to deteriorated permeability and hence insufficient shielding characteristics.

The flat, soft magnetic metal powder preferably has a particle size distribution D₅₀ of 8 to 42 μm. The powder having a particle size distribution D₅₀ of below 8 μm may have a deteriorated energy conversion efficiency. On the other hand, the particles having a size distribution D₅₀ of above 42 μm may have a deteriorated mechanical strength and tend to be broken when mechanically treated for mixing.

The particle size distribution D₅₀ represents a size range around the midpoint in a cumulative distribution in which sizes determined by a particle size distribution meter are arranged in an ascending order.

The flat, soft magnetic metal powder preferably has a specific surface area of 0.8 to 1.2 m²/g. It functions to convert energy by electromagnetic induction, and can have an increased energy conversion efficiency as its specific area increases. Increased specific surface area, however, is accompanied by decreased mechanical strength. Therefore, it should be within an optimum range. The powder having a specific surface area of below 0.8 m²/g can be densely packed but has a deteriorated energy conversion. On the other hand, the powder having a specific surface area of above 1.2 m²/g tends to be broken when mechanically treated for mixing, difficult to retain the absorber shape, and shows a deteriorated energy conversion function even when densely packed.

The specific surface area is determined by a BET tester.

Moreover, the flat, soft magnetic metal powder preferably has an aspect ratio of 17 to 20, and tap density of 0.55 to 0.75 g/ml. Still more, it is preferably surface-treated with an oxidation inhibitor.

The flat, soft magnetic metal powder for the present invention is preferably microcapsulation-treated before use. It tends to have a deteriorated volumetric resistance and dielectric breakdown strength, when packed together with soft ferrite or the like. Microcapsulation can not only prevent deterioration of its dielectric breakdown strength but also improve the strength.

Any microcapsulation method may be adopted, so long as it uses a material which can coat the flat, soft magnetic metal particle surfaces to some extent and is not harmful to energy conversion efficiency of the powder.

For example, it may use gelatin to coat the flat, soft magnetic metal particle surfaces, where the particles are dispersed in a toluene solution of gelatin and then toluene is removed by evaporation to produce the microcapsulated particles coated with gelatin. For example, the microcapsulated particles composed of gelatin and the flat, soft magnetic metal powder at about 20 and 80% by mass can have a size of about 100 μm. The microcapsulation treatment can almost double dielectric breakdown strength of the electromagnetic wave absorber.

A flame retardant to be incorporated together with the above-described electromagnetic wave absorbing filler is preferably of magnetite. Magnetite is iron oxide (Fe₃O₄), and can impart flame retardancy to the absorber and improve its thermal conductivity, when used in combination with the soft ferrite and/or flat, soft magnetic metal powder. Moreover, it can improve electromagnetic wave absorption effect of the electromagnetic wave absorber as a whole by the synergistic effect brought by its magnetic characteristics.

The magnetite preferably has a particle size distribution D₅₀ of 0.1 to 0.4 μm. It allows the soft ferrite to be densely packed, when its particle size distribution D₅₀ is kept at about one-tenth of that of the soft ferrite. The magnetite may be difficult to handle when its distribution D₅₀ is below 0.1 μm. It may not be densely packed together with the soft ferrite when its distribution D₅₀ exceeds 0.4 μm.

The particle size distribution D₅₀ represents a size range around the midpoint in a cumulative distribution in which sizes determined by a particle size distribution meter are arranged in an ascending order.

The magnetite particle is not limited in shape. It may take any desired shape, e.g., spherical, fibrous or indefinite. It is preferably fine and octahedral for the present invention to realize the electromagnetic wave absorber of high flame retardancy. The fine, octahedral magnetite particles can have a large specific surface area and high effect of imparting flame retardancy.

When the electromagnetic wave absorber of the present invention is incorporated with a composite electromagnetic wave absorbing filler in which magnetite is combined with the soft ferrite surface-treated with a silane compound having a non-functional group, the composite filler is preferably composed of 60 to 90% by mass of the soft ferrite and 3 to 25% by mass of the magnetite. The resultant absorber is suitable for high-resistance/high-insulation purposes.

When the electromagnetic wave absorber of the present invention is incorporated with a composite electromagnetic wave absorbing filler in which magnetite is combined with the flat, soft magnetic metal powder, the composite filler is preferably composed of 60 to 70% by mass of the metal powder and 3 to 10% by mass of the magnetite. The resultant absorber is suitable for purposes which need absorption of electromagnetic waves in a frequency band of from 2 to 4 GHz.

When the electromagnetic wave absorber of the present invention is incorporated with a composite electromagnetic wave absorbing filler in which magnetite is combined with the soft ferrite surface-treated with a silane compound having a non-functional group and flat, soft magnetic metal powder, the composite filler is preferably composed of 40 to 60% by mass of the soft ferrite, 20 to 30% by mass of the metal powder and 3 to 10% by mass of the magnetite. The resultant absorber is suitable for purposes which need absorption of electromagnetic waves in a broad frequency band of from MHz to 10 GHz.

The squeezable, cross-linked, grease-like electromagnetic wave absorber of the present invention is incorporated with the electromagnetic wave absorbing filler at 200 to 800 parts by mass per 100 parts by mass of the cross-linked silicone gel. The filler content beyond the above range is not desirable. When it is below 200 parts by mass, the absorber may have a deteriorated energy conversion efficiency. When it is above 800 parts by mass, on the other hand, the absorber may not be squeezed out from a syringe or the like because of decreased fluidity.

### 3. Squeezable, Cross-Linked, Grease-Like Electromagnetic Wave Absorber

The squeezable, cross-linked, grease-like electromagnetic wave absorber of the present invention is a composite material with the cross-linked silicone gel as a matrix material dispersed with the electromagnetic wave absorbing filler. When incorporated with an inorganic filler, e.g., ferrite, flat, soft magnetic metal powder or magnetite, at a high content, silicone generally becomes too viscous to be kneaded by a roll or kneader (e.g., Banbury kneader). Even when kneaded, the compound is too viscous. On the other hand, incorporation of silicone with soft ferrite surface-treated with a silane compound having a non-functional group facilitates its treatment, e.g., kneading. When roll-kneaded, silicone containing densely packed ferrite loses strength for holding ferrite and hence structural integrity. At the same time, the compound will not be homogeneous, because it tends to stick to roll surfaces. When surface-treated with a silane compound having a non-functional group, soft ferrite becomes well dispersible in cross-linked silicone gel. Moreover, microcapsulation of flat, soft magnetic metal powder brings an advantage of further facilitating treatment, e.g., kneading.

For use of the squeezable, cross-linked, grease-like electromagnetic wave absorber of the present invention, it is squeezed out of a container, e.g., syringe in which it is contained, and spread over, or poured or pressed into a space to which a sheet product is essentially inapplicable. Moreover, it has self-shape-retaining nature by which it retains its shape intact after being applied even when exposed to a light load (e.g., that occurring when it is placed on a slanted object)

The term “cross-linked” used in this specification means that the electromagnetic wave absorber of the present invention is a product of novel type, produced based on a technical concept different from that for an uncrosslinked silicone resin, which has been used thus far. The term “squeezable” means that the electromagnetic wave absorber of the present invention is applied after being squeezed out of a container, e.g., syringe, in which it is contained, to a space over which it is spread or into which it is poured or pressed, or over which it is spread, even when the space has a random shape.

### 4. Container

The squeezable, cross-linked, grease-like electromagnetic wave absorber of the present invention can be contained in a container, from which it can be squeezed out for use. The container may be represented by a syringe, tube or the like. It is not limited, so long as it has a space for containing a fluid, fluid injection and discharge port(s), piston or blade by which a fluid is injected or discharged, cap, seal and so forth, and has a function of injecting, discharging and containing an optional quantity of fluid. Taking a tube as an example, it may have a fluid injection and discharge ports; one port working for injecting and discharging fluid; both ports at first but an injection port is closed and left unused after a fluid is contained, leaving only a discharge port for use; or both ports which are closed after a fluid is contained. Moreover, it may have a varying means for closing an injection and discharge ports, e.g., plug, cap with a rotational groove, sealing under heating, closing with a seal, or the like.

The container may be equipped with one or more means selected from various types, e.g., heating, cooling, depressurizing, pressurizing, aspiration, evaporation, motoring, hydraulic, pneumatic, measuring, dust proofing, auxiliary handling, displaying, evolved gas releasing, reverse flow prevention, temperature sensing means and so forth. The most extensively used containers are syringe-shape and tube containers.

The method for containing the squeezable, cross-linked, grease-like electromagnetic wave absorber of the present invention in a container is not limited. For example, it may be contained by one of the following two methods.

(1) A cross-linked silicone gel and electromagnetic wave absorbing filler are heated while or after they are mixed to produce the squeezable, cross-linked, grease-like electromagnetic wave absorber dispersed with the filler, and then the product is contained in a container. This method can efficiently produce the absorber, because it can massively handle the starting material and filler. It is necessary to contain the product with degassing to prevent bubbles from entering the container.
(2) A mixed solution of starting material for a cross-linked silicone gel and electromagnetic wave absorbing filler is contained, and then heated together with the container to cross-link the starting material to produce the squeezable, cross-linked, grease-like electromagnetic wave absorber dispersed with the filler. This method can contain the mixed solution of low viscosity in a container, e.g., syringe, tube or the like, while preventing bubbles from entering the container more efficiently, and hence keep the product in a higher-quality condition for use.

### 5. Method for Absorbing Electromagnetic Waves

The squeezable, cross-linked, grease-like electromagnetic wave absorber of the present invention can be squeezed out of a container in which it is contained from its discharge port, and spread over an area around radiation opening(s), e.g., slit(s) or the like, to form a thin film on a box which holds an electronic device to control radiation of unnecessary electromagnetic waves through the opening(s). Some of the electronic devices held in such a box are personal computers (PCs), DVD drivers and TV sets.

### EXAMPLES

The present invention is described in detail by EXAMPLES and COMPARATIVE EXAMPLES. It is to be understood that the present invention is not limited by EXAMPLES. In EXAMPLES, The properties were determined by the following methods.

(1) Testing of diffusion (bleeding) phenomenon: A 50 g of a squeezable, cross-linked, grease-like electromagnetic wave absorber sample was placed between two glass plates and pressed to a gap of 2 mm between the plates, i.e., the sample was kept 2 mm thick. It was then placed in a horizontal or slanted condition under no load, and tested by an environment tester, where it was exposed to cycles of 30 minutes at −4° C. and 30 minutes at 100° C. for a total of 300 hours, to observe the sample conditions.
(2) Consistency: determined in accordance with JIS K 2220 with a ¼ cone
(3) Magnetism loss (permeability): determined by a permeability/induction rate analyzing system (S parameter type coaxial tube er, μr analyzing system, Anritsu & Keycom)
(4) Volumetric resistance: determined in accordance with JIS K 6249
(5) Dielectric breakdown strength: determined in accordance with JIS K
(6) Thermal conductivity: determined in accordance with the QTM method (Kyoto Electronics Manufacturing)
(7) Flame retardancy: determined in accordance with UL94
(8) Heat resistance: The sample was heated at constant 150° C. to determine penetration and thermal conductivity changing with time. It is defined as time elapsing until a change is observed.

### Example 1

A mixture of 83% by mass of Ni—Zn-based soft ferrite (BSN-714, Toda Kogyo, particle size distribution D₅₀: 1 to 10 μm) surface treated with methyltrimethoxy silane and 5% by mass of fine magnetite particles of octahedral shape (KN-320, Toda Kogyo, particle size distribution D₅₀: 0.1 to 0.4 μm), was well dispersed uniformly in 12% by mass of silicone gel (SIG5000, Shin-Etsu Chemical, curable by an addition mechanism to a consistency of 130, determined in accordance with JIS K 2220 with a ¼ cone) with defoaming treatment under a vacuum. The product was injected into a syringe (inner volume: 30 cm³, injection/discharge port cross-sectional area: 2 mm²) with defoaming treatment under a vacuum, and heated at 80° C. for 30 minutes together with the whole syringe to cross-link the gel. This produced the syringe which contained the squeezable, cross-linked, grease-like electromagnetic wave absorber of the present invention. It could be discharged from the discharge port when the syringe piston was pressed lightly by a thumb. It was tested and evaluated by the methods, described above.

The sample placed in a horizontal condition showed no diffusion (bleeding) phenomenon with its periphery kept intact. The sample placed in a slanted condition showed no trickling phenomenon. It was also observed to show a temporal change only to a limited extent.

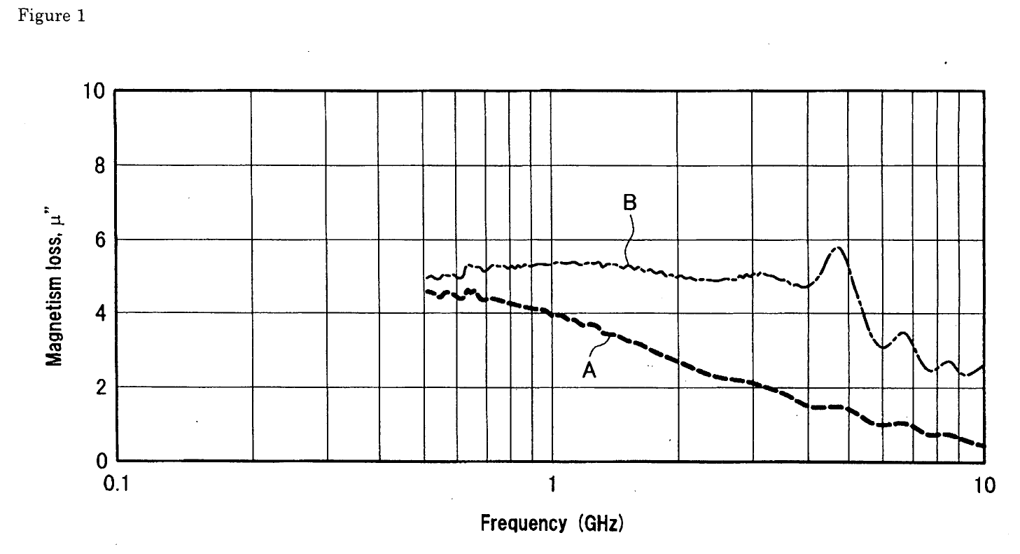

The evaluation results of the cross-linked, grease-like electromagnetic wave absorber are given in Table 1. FIG. 1 shows its magnetism loss (Line A) measured in a frequency range of from 0.5 to 10 GHz.

### Example 2

A mixture of 50% by mass of Ni—Zn-based soft ferrite (BSN-714, Toda Kogyo, particle size distribution D₅₀: 1 to 10 μm) surface treated with methyltrimethoxy silane, 25% by mass of flat soft magnetic metal powder (JEM-M, Jemco, particle size distribution D₅₀: 8 to 42 μm, self-oxidation rate: 0.26%) and 5% by mass of fine magnetite particles of octahedral shape (KN-320, Toda Kogyo, particle size distribution D₅₀: 0.1 to 0.4 μm), was well dispersed in 20% by mass of silicone gel (SIG5000, Shin-Etsu Chemical, curable by an addition mechanism to a consistency of 130, determined in accordance with JIS K 2220 with a ¼ cone) with defoaming treatment under a vacuum. The product was injected into a syringe (inner volume: 30 cm³, injection/discharge port cross-sectional area: 2 mm²) with defoaming treatment under a vacuum, and heated at 80° C. for 30 minutes together with the whole syringe to cross-link the gel. This produced the syringe which contained the squeezable, cross-linked, grease-like electromagnetic wave absorber of the present invention. It could be discharged from the discharge port when the syringe piston was pressed lightly by a thumb. It was tested and evaluated by the methods, described above.

The sample placed in a horizontal condition showed no diffusion (bleeding) phenomenon with its periphery kept intact. The sample placed in a slanted condition showed no trickling phenomenon. It was also observed to show a temporal change only to a limited extent.

The evaluation results of the cross-linked, grease-like electromagnetic wave absorber are given in Table 1. FIG. 1 shows its magnetism loss (Line B) measured in a frequency range of from 0.5 to 10 GHz.

### COMPARATIVE EXAMPLE 1

Soft ferrite not surface-treated was incorporated in the silicone gel used in EXAMPLE 1, and tested for curability. The evaluation results are given in Table 1. The mixture could not be cross-linked when it contained ferrite at 20% by mass, because of inhibited curing of the silicone gel. It had a low magnetism loss (1 GHz) of 0.5.

### COMPARATIVE EXAMPLE 2

An electromagnetic wave absorber was prepared in the same manner as in EXAMPLE 1, except that the soft ferrite was surface-treated with epoxy trimethoxy silane as a silane compound having a functional group, and evaluated. The evaluation results are given in Table 1. It had a low heat resistance of 1000 hours or less.

### COMPARATIVE EXAMPLE 3

An electromagnetic wave absorber was prepared in the same manner as in EXAMPLE 1, except that the silicone gel was not cross-linked, and evaluated. The evaluation results are given in Table 1. The diffusion phenomenon test, carried out in the same manner as in EXAMPLE 1, revealed that the sample placed in a horizontal condition was observed to diffuse (bleed) with the peripheries failing to retain the original position, and that the one placed in a slanted condition was observed also to trickle down. Moreover, it suffered a temporal change to a higher extent, because it was not cross-linked.

### COMPARATIVE EXAMPLE 4

An electromagnetic wave absorber was prepared in the same manner as in EXAMPLE 2, except that the silicone gel was not cross-linked, and evaluated. The evaluation results are given in Table 1. It was observed to diffuse (bleed) and trickle down, and to suffer a temporal change to a higher extent, as was the case with the absorber prepared in COMPARATIVE EXAMPLE 3.

TABLE 1

| | | | | EXAMPLES | | COMPARATIVE EXAMPLES | | | |
|---|---|---|---|---|---|---|---|---|---|
| | | | | 1 | 2 | 1 | 2 | 3 | 4 |
| Electromagnetic | Soft | D₅₀ | μmn | 1~10 | 1~10 | 1~10 | 1~10 | 1~10 | 1~10 |
| wave absorber | ferrite | Surface treatment agent | — | Methyl- | Methyl- | Untreated | Epoxy | Methyl- | Methyl- |
| composition | | | | trimethoxy | trimethoxy | | trimethoxy | trimethoxy | trimethoxy |
| | | | | silane | silane | | silane | silane | silane |
| | | pH after surface treatment | | <8.2 | <8.2 | >8.5 | <8.2 | <8.2 | <8.2 |
| | | Content | wt % | 83 | 50 | 20 | 83 | 83 | 50 |
| | | | | | | (upper limit) | | | |
| | Flat, soft | D₅₀ | μm | — | 8~42 | — | — | — | 8~42 |
| | magnetic | Content | wt % | 0 | 25 | 0 | 0 | 0 | 25 |
| | metal powder | | | | | | | | |
| | Magnetite | D₅₀ | μm | 0.1~0.4 | 0.1~0.4 | — | 0.1~0.4 | 0.1~0.4 | 0.1~0.4 |
| | | Content | wt % | 5 | 5 | 0 | 5 | 5 | 5 |
| | Silicone | Consistency | — | 130 | 130 | 130 | 130 | 130 | 130 |
| | | Content | wt % | 12 | 20 | 80 | 12 | 12 | 20 |

| | | | | | | | | |
|---|---|---|---|---|---|---|---|---|
| Electromagnetic | Magnetism loss (see FIG. 1) | μ″ | A | B | 0.5(1 GH) | — | — | — |
| wave absorber | Volumetric resistance | Ωm | 2 × 10¹¹ | 10⁷ | — | 2 × 10¹¹ | — | — |
| evaluation | Dielectric breakdown strength | KV/mm | 4.5 | 0.2 | — | 4.5 | — | — |
| results | Thermal conductivity | W/ | 1.2 | 0.8 | — | 1.2 | — | — |
| | | m · K | | | | | | |
| | Specific gravity | — | 2.8 | 3.0 | — | 2.8 | — | — |
| | Consistency | — | 80 | 50 | — | 80 | — | — |
| | Flame retardancy (UL94) | — | V-0 | V-0 | — | V-0 | — | — |
| | | | equivalent | equivalent | | equivalent | | |
| | Heat resistance (150° C.) | Hr | >1000 | >1000 | — | <1000 | — | — |
| | Diffusion/trickling phenomena | — | Not | Not | — | Not | Observed | Observed |
| | | | observed | observed | | observed | | |

The squeezable, cross-linked, grease-like electromagnetic wave absorber of the present invention contains an electromagnetic wave absorbing filler uniformly in a cross-linked silicone gel, and shows no phase separation or segregation even at a high filler content, to have improved electromagnetic wave absorbing capability. It has various other advantages. It can be contained in a container, e.g., tube or syringe, and squeezable from a container by a weak force (e.g., by hand from a tube or by air which presses a syringe piston). Moreover, it can be formed into any shape by a force after being squeezed out. Still more, it shows no diffusion phenomenon (bleeding phenomenon) in a device in which it is used, and can retain its shape intact so long as it is allowed to remain as it is in the ordinary course of events even when exposed to a light load (e.g., that occurring when it is placed on a slanted object), i.e., showing self-shape-retaining nature. Still more, it shows limited temporal aging, because it is already cross-linked. Therefore, it can absorb unnecessary electromagnetic waves emitted from a box in which an electronic device is held by merely coating box opening(s) with a thin film to abate noise radiation efficiency. As such, it is greatly more advantageous costwise than a conventional absorber, which needs a secondary treatment and complex gluing works.

1: A squeezable, cross-linked, grease-like electromagnetic wave absorber comprising a cross-linked silicone gel dispersed with an electromagnetic wave absorbing filler, which shows self-shape-retaining nature in spite of its fluidity and contains the filler at 200 to 800 parts by mass per 100 parts by mass of the cross-linked silicone gel.

2. The squeezable, cross-linked, grease-like electromagnetic wave absorber according to claim 1, wherein the cross-linked silicone gel has a consistency of 50 to 200, determined in accordance with JIS K 2220 with a ¼ cone.

3. The squeezable, cross-linked, grease-like electromagnetic wave absorber according to claim 1, wherein the electromagnetic wave absorbing filler is a mixture of electromagnetic wave absorbing agent and flame retardant.

4. The squeezable, cross-linked, grease-like electromagnetic wave absorber according to claim 3, wherein the electromagnetic wave absorbing agent is of a soft ferrite surface-treated with a silane compound having a non-functional group and/or flat, soft magnetic metal powder.

5. The squeezable, cross-linked, grease-like electromagnetic wave absorber according to claim 4, wherein the soft ferrite surface-treated with a silane compound having a non-functional group is surface treated with dimethyldimethoxy silane or methyltrimethoxy silane.

6. The squeezable, cross-linked, grease-like electromagnetic wave absorber according to claim 4, wherein the soft ferrite surface-treated with a silane compound having a non-functional group is kept at a pH of 8.5 or less.

7. The squeezable, cross-linked, grease-like electromagnetic wave absorber according to claim 3, wherein the flame retardant is of magnetite.

8. A container which contains the squeezable, cross-linked, grease-like electromagnetic wave absorber of claim 1.

9. The container according to claim 8 which takes a form of syringe or tube.

10. A method for producing the container according to claim 8, wherein a squeezable, cross-linked, grease-like electromagnetic wave absorber, produced by heating a mixture of starting material for a cross-linked silicone gel and electromagnetic wave absorbing filler while or after they are mixed to disperse the filler in the absorber, is contained therein.

11. A method for producing the container according to claim 8, wherein a squeezable, cross-linked, grease-like electromagnetic wave absorber is produced by heating the container which has already contained a mixed solution of starting material for a cross-linked silicone gel and electromagnetic wave absorbing filler to disperse the filler in the absorber.

12. A method for absorbing unnecessary electromagnetic waves, wherein the squeezable, cross-linked, grease-like electromagnetic wave absorber contained in the container according to claim 8 is applied to an area around an opening for heat radiation on a box to be formed into a thin film thereon to control radiation of unnecessary electromagnetic waves from the opening.

13. The squeezable, cross-linked, grease-like electromagnetic wave absorber according to claim 2, wherein the electromagnetic wave absorbing filler is a mixture of electromagnetic wave absorbing agent and flame retardant.

14. The squeezable, cross-linked, grease-like electromagnetic wave absorber according to claim 13, wherein the electromagnetic wave absorbing agent is of a soft ferrite surface-treated with a silane compound having a non-functional group and/or flat, soft magnetic metal powder.

15. The squeezable, cross-linked, grease-like electromagnetic wave absorber according to claim 5, wherein the soft ferrite surface-treated with a silane compound having a non-functional group is kept at a pH of 8.5 or less.

16. The squeezable, cross-linked, grease-like electromagnetic wave absorber according to claim 4, wherein the flame retardant is of magnetite.

17. A container which contains the squeezable, cross-linked, grease-like electromagnetic wave absorber of claim 2.

18. A method for producing the container according to claim 9, wherein a squeezable, cross-linked, grease-like electromagnetic wave absorber, produced by heating a mixture of starting material for a cross-linked silicone gel and electromagnetic wave absorbing filler while or after they are mixed to disperse the filler in the absorber, is contained therein.

19. A method for producing the container according to claim 9, wherein a squeezable, cross-linked, grease-like electromagnetic wave absorber is produced by heating the container which has already contained a mixed solution of starting material for a cross-linked silicone gel and electromagnetic wave absorbing filler to disperse the filler in the absorber.

20. A method for absorbing unnecessary electromagnetic waves, wherein the squeezable, cross-linked, grease-like electromagnetic wave absorber contained in the container according to claim 9 is applied to an area around an opening for heat radiation on a box to be formed into a thin film thereon to control radiation of unnecessary electromagnetic waves from the opening.
